(19) United States
(12) Patent Application Publication
(10) Pub. No.: US 2013/0051173 A1
(43) Pub. Date: Feb. 28, 2013

(54) Mixer Comprising a Deflector Surface

(71) Applicants: Willy Bräker, Wil (CH); Danijel Dolic, Niederuzwil (CH); Martin Hartsieker, Bad Oeynhausen (DE); Peter Braun, Kreuzlingen (CH); Bernd Schmidt, Kirchberg (CH); Rene König, Amriswil (CH)

(72) Inventors: Willy Bräker, Wil (CH); Danijel Dolic, Niederuzwil (CH); Martin Hartsieker, Bad Oeynhausen (DE); Peter Braun, Kreuzlingen (CH); Bernd Schmidt, Kirchberg (CH); Rene König, Amriswil (CH)

(73) Assignee: BÜHLER AG, Uzwil (CH)

(21) Appl. No.: 13/574,857

(22) PCT Filed: Jan. 27, 2011
(86) PCT No.: PCT/EP2011/051104

§ 371 Date: Aug. 28, 2012

(30) Foreign Application Priority Data
Jan. 28, 2010 (EP) 10151872.8

(51) Int. Cl. A23G 1/10; B01F 15/06; B01F 7/00

(52) U.S. Cl. 366/145; 366/302; 366/296

(57) ABSTRACT

The application relates to a device for mixing and kneading masses (1), in particular chocolate masses, and to a method for mixing and kneading masses, in particular chocolate masses. The device comprises a kettle (2) having an inner wall (3), which at least partially emulates the outer surface of a rotational body, and a shaft (11) and at least one tool (10, 13) fastened thereto. At least one, in particular planar, deflector surface (8) is arranged in the kettle (2), the surface extending in the axial direction.

The invention relates to a device for mixing and kneading masses, in particular chocolate masses, and to a method for mixing and kneading masses, in particular chocolate masses.

During the production and processing in particular of fatty masses, such as chocolate, the components of the mass are first of all mixed with one another, and the basic mass becomes homogeneous and plastic during mixing and optionally during kneading. The components of the mass are solid and/or liquid constituents, i.e. dry constituents, such as cocoa powder, granular crystal sugar or milk powder, liquids and/or pasty masses.

DE1782585, EP 565887 and DE19637098, for example, disclose mixing devices which have a kettle with a driven shaft, wherein tools, in particular mixing, homogenizing, shearing, scraping and/or conveying tools, are arranged on the shaft.

Mixing devices generally have a kettle with an inner wall which at least partially imitates the outer surface of a rotational body. This may be in particular a cylinder jacket. However, the inner wall may also correspond to a conical body, such as a cone. The rotating tools can then brush along a large part of the inner wall of the kettle. As a rule, the mixing and kneading are carried out in a double cylinder trough with two shafts rotating in an axially parallel manner.

The kettle, or the axis of the rotational body, and the shaft are preferably to be arranged horizontally. However, the kettle may also be arranged in an inclined manner or even vertically such that the mass, assisted by gravity, is driven along the kettle axis. Mixers having substantially horizontally arranged shafts are referred to below as horizontal mixers.

The kettles generally have a feed opening in the upper region for feeding in the mass while a discharge is arranged at the lowest point of the kettle.

In the mixer, the mass is driven about the shaft by the tools. In a horizontal mixer, the mass is raised by the tools in a rising direction, having arrived at the top is detached from the tool and dropped owing to gravity through the intermediate space between tool and shaft onto the lower part of the inner wall of the kettle, from where the mass is again picked up by the tools. The components of the mass are mixed in the process and the mass is homogenized.

Starting from that which is known, the invention is based on the object of providing a device and a method, with which the mixing and/or kneading operations are designed more effectively and the processed mass can be better and more rapidly prepared for subsequent processes.

The object is achieved by a device for mixing and kneading masses, in particular chocolate masses. Said device comprises a kettle which, upon correct use, is preferably to be arranged horizontally and has an inner wall, at least part of which, in particular up to 50-90% of the surface of which, furthermore in particular up to 60-85%, and furthermore in particular up to 70-80%, imitates the outer surface of a rotational body, in particular a cylinder jacket.

In addition, the device comprises a shaft which is arranged in the kettle, preferably precisely one shaft, with at least one tool fastened thereto. For the mixing and kneading, use is preferably made of a shearing tool. The latter, in contrast to a scraping tool, used, for example, in a conch, is at a greater distance from the kettle wall and therefore enables shearing of the mass between tool and wall.

According to the invention, at least one, in particular planar, deflector surface is arranged in the kettle, said deflector surface extending in the axial direction, preferably along the entire axial length of the tool or tools or of the kettle. The deflector surface is preferably arranged parallel to the shaft.

The deflector surface is located in particular outside and/or within the outer surface of the rotational body. That is to say, the deflector surface is not part of the outer surface of the rotational body, in particular is not part of the inner wall of the kettle, having the contour of a rotational body.

In a device of this type, not only can components of a mass be moved and mixed as a result. The entire mass or parts thereof can undergo a compressive action on the deflector surface according to the invention, said compressive action going beyond the striking of the mass against the lower part of the inner wall of the kettle as the mass drops downwards. The mass can thus be subjected to a kneading operation.

If the deflector surface is arranged within the rotational body, the path of the revolving tools has to lead around the deflector surface, and, for this purpose, the tools may be driven, for example, by an eccentrically mounted axis and/or mounted resiliently.

In a preferred embodiment of the invention, the shaft is arranged coaxially with the axis of the rotational body. When rigid tools are used, this means that the deflector surface is arranged outside the rotational body.

The deflector surface encloses an angle of less than 90° with the tangential plane of the rotational body at the transition between rotational body and deflector surface.

The deflector surface is preferably arranged vertically in a horizontally oriented kettle, and therefore the surface normal points horizontally. Then, owing to gravity, the mass hurled against the deflector surface can run down or drop off from the deflector surface.

In order to assist the kneading effect, the kettle advantageously provides space for a free trajectory, in particular parabolic trajectory, of mass accelerated by the tool, in particular of mass accelerated tangentially from the inner wall. The deflector surface can thus be mounted in such a manner that mass is hurled onto the surface through the space for the free trajectory. The internal space of the kettle preferably extends beyond the rotational body, thus producing a breakaway edge, from which the mass is accelerated tangentially to the sectional surface of the rotational body.

In the case of substantially horizontally arranged mixers, the space for the trajectory is located in the upper half, and therefore the accelerated mass passes approximately through a parabolic trajectory. At a suitable starting speed, the mass can then strike against the deflector surface.

The distance between breakaway edge and deflector surface is preferably not greater than the diameter of the rotational body.

The space can also be provided by the kettle having a neck-like opening which is arranged substantially parallel to the axis and has at least one shoulder surface. In addition, the opening can be used for filling and/or ventilating and/or cleaning the kettle and/or for exchanging the tools.

The object is furthermore achieved by a mixer, in particular as described above, consisting of a kettle which, upon correct use, is preferably to be arranged horizontally and has an at least partially cylindrical inner wall, with a shaft, preferably precisely one shaft, and at least one tool which is fastened thereto, in particular a stripping tool, wherein the kettle has, according to the invention, a neck-like opening which is arranged parallel to the axis of the rotational body and has at least one shoulder surface, which opening extends substantially over the entire length of the kettle.

An opening which, in the case of a horizontal mixer, is arranged in the upper half of the kettle can be used for filling and/or ventilating and/or cleaning the kettle and/or for exchanging the tools. It may also provide space for the trajectory of mass accelerated in the mixer.

At least one shoulder surface of the opening preferably forms a deflector surface. The neck-like opening may also be designed in such a manner that it has two shoulder surfaces which each form deflector surfaces, and therefore the mass can be hurled against the deflector surface in both directions of rotation of the tools. The deflector surface is preferably oriented vertically when the kettle is correctly arranged horizontally.

The opening angle of the axially running opening, i.e. the angle between the connecting line between shaft axis and breakaway edge, and the connecting line between shaft axis and transition from the kettle wall and deflector surface is selected in such a manner that, for a wide range of masses to be mixed, the masses do not spray out of the mixer, firstly, and, secondly, reach the deflector surface. The opening angle is preferably smaller than 120°, preferably, in particular in the case of single-shaft devices, is smaller than 90°, furthermore preferably smaller than 60°.

A covering, for example, a hinged lid, may be provided for the opening.

In an advantageous embodiment of the invention, the tool is designed as a ribbon. The latter, firstly, sets the mass into rotation and hurls the mass against the deflector surface and, secondly, the mass is driven in the axial direction through the mixer. The conveying direction may be reversed upon a reversal of the direction of rotation, and therefore the mass can be moved to and fro in the axial direction upon a change in the directions of rotation.

In a further advantageous embodiment of the invention, the device has a speed controller and/or a speed regulator for the rotational speed of the shaft and the tools. This serves in particular for adapting the trajectory or parabolic trajectory to the properties of the mass, which are provided, for example, by composition, the quantity, the specific weight, the consistency, etc.

With the given arrangement of the deflector surface, by an adjustment of the speed care can be taken to ensure that the mass, for example, firstly does not fly out of the kettle and, secondly, a large portion of the mass strikes against the deflector surface. For this purpose, the tangential speed, which depends on the number of revolutions of the shaft and the properties of the mass upon detachment of the mass from the inner wall has to lie within a suitable value range. The necessary speed, or number or revolutions, can easily be determined by routine tests.

As an alternative, the deflector surface may also be provided, so as to be changeable, for example, the position of the deflector surface may be displaceable and/or the height and/or the surface size may be variable, and/or the entire deflector surface may be exchangeable, depending on which impact area is desired depending on the mass fed and the adjustable rotational speeds. As an alternative, the trajectory of the mass may also be limited by an additional component, for example an inserted wedge.

In addition, the object on which the invention is based is achieved by a device for mixing and kneading of fatty masses, in particular chocolate masses, in particular as described above, consisting of a kettle which, upon correct use, is preferably to be arranged horizontally and has an at least partially cylindrical inner wall, the kettle having a shaft and at least one tool which is fastened thereto. In particular, this is a shearing tool. According to the invention, two counter-rotating ribbons or parts of counter-rotating ribbons are attached to the shaft and preferably, at least partially, overlap. The ribbons preferably overlap in the vicinity of the outlet of the kettle, which outlet may be located in the center of the kettle.

The ribbons or ribbon pieces are in particular designed in such a manner that they act at the same time as a shearing tool.

The shaft drive can than take place only in one direction and the mass is driven in opposite directions by means of right-handed and left-handed ribbons.

The ribbons in one direction of rotation may be designed so as to be linked together, or may be present as individual pieces. The individual pieces are in each case parts of ribbons. They may be spaced apart from one another. The imaginary connecting line of the individual pieces may be in the shape of a continuous ribbon.

The counter-rotating ribbons overlapping in the vicinity of the outlet, for example in the center of the kettle, are preferably arranged in such a manner that the mass is driven toward the overlapping region where the kettle discharge is preferably located, and therefore clean emptying can be ensured.

In addition, at least one stirring paddle may be arranged on the shaft, the stirring paddle increasing the mixing effect.

The stirring paddle may be shorter than the tool since the mixing plays a role specifically at lower rotational speeds at which the influence of the centrifugal force in comparison to gravity is smaller and the predominant portion of the mass is located in the lower half of the kettle.

In an advantageous embodiment, the device has a temperature control means. With the latter, the kettle and/or the inner wall and/or the mass fed in can be heated and/or cooled. This is particularly favorable for the processing of chocolate mass which is heated at the beginning in order to make the mass smooth, and which mass, in a later phase, after mechanical energy has been introduced into the mass, may optionally also be cooled.

The chocolate mass is advantageously processed at a temperature of between 35° C. and 50° C.

In addition, the object on which the invention is based is achieved by a method for mixing and kneading masses, in particular chocolate masses, wherein, in a mixer, in particular as described above, the mass is hurled against a deflector surface by a tool, in particular a stripping tool.

By means of the hurling operation and the compressive action upon impact against the deflector surface, the mass is subjected to a kneading operation. The latter goes beyond the processing of the mass with tools, in which, for example, shearing forces act on the mass, or the dropping down of the mass owing to gravity, since the speed component in the hurling direction, in particular the tangential speed, is used at the same time.

In a horizontal mixer, the mass undergoes two compressive actions during one revolution of the shaft, firstly upon impact against the deflector surface, and secondly upon dropping down onto the lower side of the kettle. The mass is therefore kneaded very effectively. Since more than one compressive action takes place per revolution and because said compressive actions take place in different directions, the doughy mass may furthermore be folded, which further assists the kneading process.

In an advantageous embodiment of the method, in a mixer with a kettle having at least one partially cylindrical inner wall, in particular a horizontal mixer, the mass is accelerated tangentially with respect to the cylindrical inner wall. The mass then passes through an oblique trajectory before impacting against the deflector surface.

In this arrangement, the rotational speed can be optionally adapted to the conditions in the kettle, in particular to the properties of the mass, and therefore a large part of the mass strikes at a high speed against the deflector surface where it undergoes a compressive action.

In a preferred embodiment of the invention, the speed of the at least one tool is controlled or regulated, in particular for adapting the trajectory or parabolic trajectory to the properties of the mass, such as composition, quantity, specific weight, consistency, temperature, etc.

The suitable rotational frequency is preferably determined empirically depending on the composition of the mass.

The mass is preferably first of all moved at a first speed in a horizontal mixer, where the predominant portion of the components of the mass is mixed. The mass is subsequently moved at a second speed, wherein the mass is hurled against the deflector surface and the predominant portion of the mass is kneaded.

The speeds are preferably to be adjusted depending on the product in such a manner that the theoretical point of impact is located in the center of the deflector surface.

The process or the quality of the mixing product can be regulated by means of torque absorption and/or power consumption.

The temperature of the mass can additionally be controlled during the processing.

The invention is explained in more detail below in exemplary embodiments with reference to drawings, in which

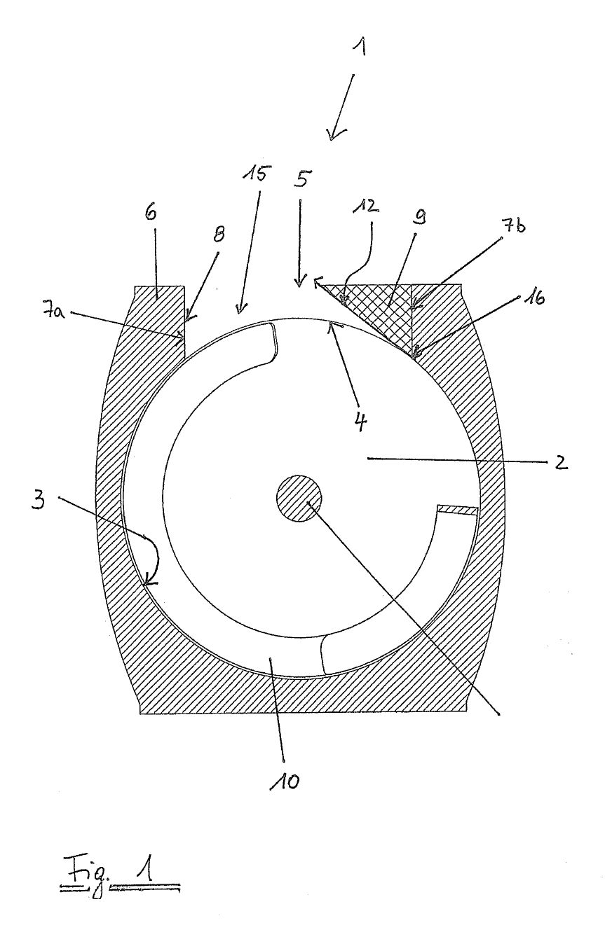

FIG. 1 shows a schematic sectional illustration of a device according to the invention;

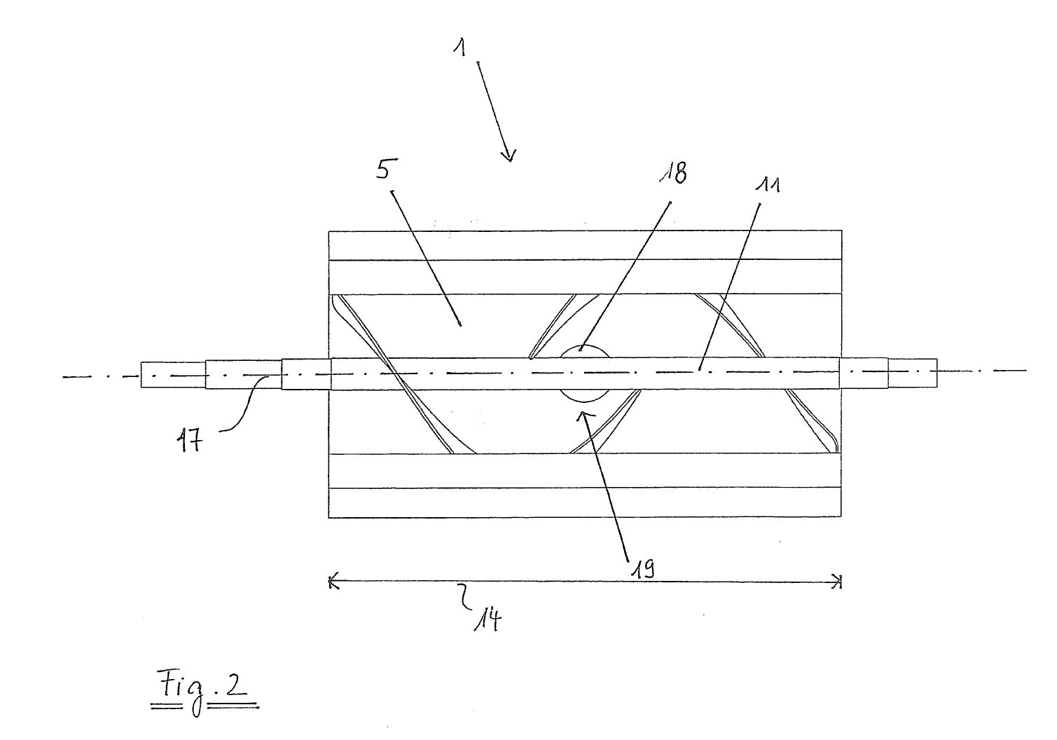

FIG. 2 shows a plan view of a device according to the invention;

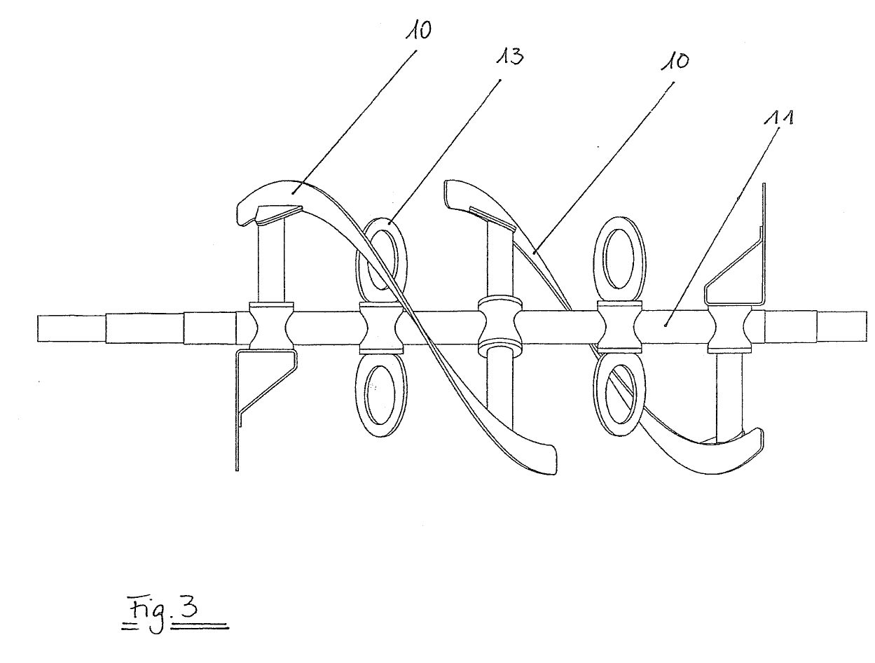

FIG. 3 shows a plan view of a shaft with first and second tools.

FIG. 1 shows a schematic sectional illustration of a mixing and kneading device 1 according to the invention. The horizontal mixer 1 shown has a kettle 2 with an inner wall 3 which at least partially corresponds to a cylinder jacket 4.

The kettle has a neck-like opening 5. A lateral wall 6 of the opening 5 is designed as a shoulder surface 7a which acts as a deflector surface 8. The latter lies outside the cylinder jacket 4. In the exemplary embodiment shown, the deflector surface 8 is arranged on the vertical. It may alternatively enclose smaller angles, of between 45 and 90 degrees, with the horizontal.

That shoulder surface 7b of the opening 5 which is opposite the deflector surface 8 is optimized with an inserted wedge 9. The latter prevents heat from escaping from the kettle 2, which is typically temperature-controlled, and prevents the mass from sloshing over.

The wedge 9 may be a fixed part of the device 1 or may be removable. In that case, it can be removed, for example, for cleaning or even does not need to be used at all, depending on the mass to be processed.

In the example shown, the mixer 1 is operated with a single-axis mixing mechanism, wherein the shaft 11 is arranged coaxially with respect to the cylinder surface 4. The mixing mechanism consists of two or more ribbons 10 which are driven by the shaft 11 along the inner wall 3.

The ribbons 10 drive the mass, which is not illustrated in the figure, around in a mixer 1 and shear said mass with respect to the wall.

At a sufficiently high speed of revolution, the centrifugal force of the mass is greater than gravity. In this case, the FROUDE number=Dₖn²π/g is greater than 1(where Dₖ is the inside diameter of the kettle, n is the rotational frequency of the mixing mechanism and g is the acceleration of gravity).

The wedge 9 is designed in such a manner that space 15 is provided within the neck-like opening 5 for a free trajectory of mass accelerated by the tool.

When the mass reaches a breakaway edge 16 at the opening 5, said mass begins to follow an oblique trajectory, wherein the mass has an initial speed in the tangential direction 12. If said tangential speed is of a sufficient size, which depends on the speed of revolution of the shaft and the properties of the masse, the mass is hurled against the deflector surface 8.

The mass is compressed upon striking against the deflector surface 8 and is subsequently folded as it drops down and is picked up again. In this manner, the mass is subjected to a kneading operation.

The speeds are to be adjusted depending on the product in such a manner that the theoretical point of impact is level with the shoulder surface 7 which approximately corresponds to the radius of the kettle 2, preferably to half the kettle radius, and furthermore preferably to a quarter of the kettle radius.

If the adjusted point of impact is too low, an excessive portion of the mass may not impact against the shoulder surface at all but rather remains within the kettle. This portion is then not compressed at the deflector surface 8.

After striking against the deflector surface, the mass drops down into the kettle 2 owing to gravity and is picked up again and entrained by the ribbons 10.

FIG. 2 shows a plan view of a horizontal mixer 1 according to the invention.

Two right-handed and left-handed ribbons 10 are attached to the shaft 11 and overlap in the kettle center 19, i.e. in the region of the discharge 18. The ribbons drive the mass into the kettle center 19, which results in clean emptying.

The pitch of the ribbons 10 is preferably approximately 0.6 times the kettle length.

The ribbons have a rectangular cross section. The neck-like opening 5 extends parallel to the axis 17 of the rotational body virtually over the entire length 14 of the mixer 1.

FIG. 3 shows a plan view of a shaft 11 with first and second tools 10, 13. In addition to the ribbons 10, oblique stirring paddles 13 may be attached to the shaft 11.

1-16. (canceled)

17. A device for mixing and kneading masses,
with a kettle,
wherein at least part of the inner wall of the kettle imitates the outer surface of a rotational body,
and with a shaft and at least one tool fastened thereto,
wherein at least one deflector surface is arranged in the kettle, said deflector surface extending in the axial direction.

18. The device as claimed in claim 17, wherein the device comprises precisely one shaft.

19. The device as claimed in claim 17, wherein the tool is a shearing tool.

20. The device as claimed in claim 17, wherein the shaft is arranged coaxially with the axis of the rotational body.

21. The device as claimed in claim 17, wherein the kettle pro-vides space for a free trajectory of mass accelerated by the tool.

22. The device as claimed in claim 17, wherein the kettle has a neck-like opening which is arranged parallel to the axis of the rotational body and has at least one shoulder surface.

23. The device as claimed in claim 17, wherein the tool is a ribbon.

24. The device as claimed in claim 17, wherein the device has a speed controller and/or a speed regulator for the rotational speed of the shaft.

25. A device as claimed in claim 17, wherein two counter-rotating ribbons or parts of counter-rotating ribbons are attached to the shaft.

26. The device as claimed in claim 17, wherein at least one stirring paddle is arranged on the shaft.

27. The device as claimed as claimed in claim 17, wherein the device has a temperature control means for heating and/or cooling the kettle and/or the inner wall and/or the mass.

28. A method for mixing and kneading masses, wherein in a mixing and kneading device the mass is hurled against a deflector surface by at least one tool.

29. The method as claimed in claim 28, wherein in a mixing and kneading device with a kettle having at least one partially cylindrical inner wall the mass is accelerated tan-gentially with respect to the cylindrical inner wall, and passes through an oblique trajectory before impacting against the deflector surface.

30. The method as claimed in claim 28, wherein the speed of the at least one tool is controlled or regulated.

31. The method as claimed in claim 28, wherein the mass is first of all moved at a first speed in a horizontal mixer, wherein the components of the mass are predominantly mixed, and the mass is subsequently moved at a second speed, wherein the mass is hurled against the deflector surface and the mass is predominantly kneaded.

32. The device as claimed in claim 28, wherein the temperature of the mass is regulated during the processing.
